(19) United States
(12) Patent Application Publication
(10) Pub. No.: US 2017/0348186 A1
(43) Pub. Date: Dec. 7, 2017

(54) MOTORIZED BED FRAME WITH VIBRATION MOTOR

(71) Applicant: W. SILVER PRODUCTS LLC, Vinton, TX (US)

(72) Inventor: Luis Garcia, El Paso, TX (US)

(21) Appl. No.: 15/170,215

(22) Filed: Jun. 1, 2016

(51) Int. Cl. A61H 23/02; A47G 9/02; A61G 7/015

(52) U.S. Cl. CPC A61H 23/02; A61G 7/015; A47G 9/0238; A61H 2205/081

(57) ABSTRACT

A motorized bed has a base frame and an articulating frame. A mattress backing is supported by the articulating frame. A vibration motor mounted to the articulating frame by a vibration motor mount. A flexible bracket is fixed to a lower surface of the articulating frame and the vibration motor such that the vibration motor is suspended from the lower surface of the articulating frame.

### TECHNICAL FIELD

The invention relates to motorized bed frames; more particularly, the present invention relates to a mounting of a vibrational motor on a motorized bed.

### BACKGROUND OF THE INVENTION

It is well-known to provide motor driven bed frames with vibrational motors that transfer vibrations to mattresses to simulate massage. These vibrational motors are typically mounted to some portion of the bed frames wherein a motor flange extends through a mattress support or backing. The flange providing the bulk of the transfer of the motor vibration to the mattress.

It is an important function of the vibrational motors to transfer simulated massage to an individual resting on the mattress. It is also important for the motor to be accessible for maintenance and repair. Prior attempts to provide desirably functional and accessible vibrational motors have failed to achieve a level of function and convenience that is optimal in the field of motorized bed frames.

The present invention is provided to solve the problems discussed above and other problems, and to provide advantages and aspects not provided by prior motorized bed frames of this type. A full discussion of the features and advantages of the present invention is deferred to the following detailed description, which proceeds with reference to the accompanying drawings.

### SUMMARY OF THE INVENTION

A first aspect of the invention is directed to a motorized bed. The bed comprises a base frame and an articulating frame. The articulating frame is attached to the base frame and has an upper surface on which a mattress is supported and an opposite lower surface. The articulating frame comprises a linking frame, a plurality of support frames and support members, a mattress backing, and a vibration motor. The linking frame is attached to the base frame. The support frames are pivotally mounted on the linking frame. The support members join the support frames with the linking frame. The mattress backing is supported by the support frames. The vibration motor is mounted to the articulating frame by a vibration motor mount. The vibration motor mount comprises a flexible bracket fixed to the lower surface of the articulating frame and the vibration motor to suspend the vibration motor from the lower surface of the articulating frame.

The first aspect of the invention may comprise one or more of the following features, alone or in any reasonable combination. The motorized bed may further comprise an aperture in the mattress backing wherein the vibration motor is mounted within the aperture. The motorized bed may further comprise a cushion within the aperture and between vibration motor and the mattress backing. The motorized bed may further comprise a cover attached to the lower surface of the articulating frame and covering the vibration motor and the flexible bracket. The cover may be attached to the mattress backing by a hook and loop fastener. The flexible bracket may be produced from a fabric. The fabric may comprise woven strands. The message motor may comprise a flange joined to a curved motor housing wherein the flange is oriented downwardly relative to the lower surface and the curved housing extends into the aperture. The curved motor housing may extend through the aperture and upwardly such that a portion of the curved motor housing extends above a plane defined by the upper surface of the mattress backing. The flange may be attached to the flexible bracket by mechanical fasteners. The flexible bracket may deflect under forces provided by the vibration motor. The flexible bracket may be deflectable such that the vibration motor is movable within the aperture. The mattress backing may be produced from a rigid material. The mattress backing may be produced from a wood. The flexible bracket may be fastened to the mattress backing with a mechanical fastener.

A second aspect of the invention is also directed to a motorized bed. The bed comprises a base frame and an articulating frame a base frame. The articulating frame is attached to the base frame and has an upper surface on which a mattress is supported and an opposite lower surface. The articulating frame comprises a linking frame attached to the base frame, a plurality of support frames pivotally mounted on the linking frame, a plurality of support members joining the support frames with the linking frame; and a mattress backing supported by the support frames comprising an upper surface on which a mattress is supported, an opposite lower surface, and an aperture passing therethrough. A vibration motor mounted is to the articulating frame and extends within the aperture in the mattress backing. The vibration motor comprises a flange and a curved motor housing joined to the flange wherein the flange is oriented downwardly relative to the lower surface of the mattress backing and the curved housing extends into the aperture in the mattress backing. A vibration motor mount attaches the vibration motor to the mattress backing and orients the vibration motor within the aperture.

The second aspect of the invention may comprise one or more of the following features, alone or in any reasonable combination. The motor mount may be deflectable such that the vibration motor is movable within the aperture. The motorized bed may further comprise a cushion within the aperture and between vibration motor and the mattress backing. The vibration motor mount may comprise a flexible bracket fixed to the lower surface of the articulating frame and the vibration motor to suspend the vibration motor from lower surface of the articulating frame

A third aspect of the invention is also directed to a motorized bed. The bed comprises a base frame and an articulating frame attached to the base frame. The articulating frame comprises a linking frame attached to the base frame, a plurality of support frames pivotally mounted on the linking frame, a plurality of support members joining the support frames with the linking frame, and a mattress backing produced from a rigid material and supported by the support frames. The mattress backing comprises an upper surface on which a mattress is supported, an opposite lower surface, and an aperture passing therethrough. A vibration motor is mounted within the aperture. The vibration motor comprises a flange and a curved motor housing joined to the flange. The flange is oriented downwardly relative to the lower surface of the mattress backing, and the curved housing extends into and through the aperture and upwardly such that a portion of the curved motor housing extends above a plane defined by the upper surface of the mattress backing. A vibration motor mount comprises a flexible bracket produced from a fabric of woven strands fixed to the lower surface of the mattress backing and the vibration motor to suspend the vibration motor from lower surface of the mattress backing. The flexible bracket is deflectable such that the vibration motor is movable within the aperture. A cushion is located within the aperture and between vibration motor and the mattress backing. A cover is attached to the lower surface of the mattress backing and covers the vibration motor and the flexible bracket wherein the cover is attached to the mattress backing by a hook and loop fastener.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an isometric view of a motorized bed frame;

FIG. 2 is an isometric view of a motorized bed frame with a mattress backing or support removed;

FIG. 3 is an isometric view of the motorized bed frame of FIG. 1 showing an articulating frame in an alternate position relative to FIG. 1;

FIG. 4 is a side plane view of the motorized bed frame if FIG. 1;

FIG. 5 is an exploded view of the motorized bed frame of FIG. 1;

FIG. 6 is an isometric view of a motorized bed frame showing a mattress backing and massage motors;

FIG. 7 is a side cross-sectional view of a motorized bed frame having massage motors;

FIG. 8 is a partial cross-sectional view of a motorized bed frame; and

FIG. 9 is a partial cross-sectional view of a motorized bed frame illustrating a flexible nature of a woven fabric bracket.

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

Referring to the figures, a motorized bed 10 comprises a base frame 14 and an articulating frame 100. One of ordinary skill in art is familiar with this arrangement wherein the articulating frame 100 is movable relative to the base frame 14.

The base frame 14 is provided with opposing guide rails 18.

The articulating frame 100 includes a linking frame 104 movably mounted on the base frame 10, a first support frame 108 is pivotally attached to the linking frame 104, support members or beams 112 pivotally join the base frame 10 with the articulating frame 100 via a padded member (not shown), which is joined to the first support frame 108, a second support frame 116 is pivotally joined to the linking frame 104, a third support frame 120 is pivotally mounted to the second support frame 116, additional support beams 124 pivotally join the linking frame 104 with and the third support frame 120.

The linking frame 104 is outfitted with rollers 126 which extend downwardly. The rollers 126 are received within the opposing guides of the base frame 14 and traverse therein.

Typical furniture drive motors 128 are pivotally joined to the linking frame 104. These furniture drive motors 128 include a cylinder which extends from a housing in response to an electrical signal and are well known in the art of motorized beds. Opposing ends of each drive motor 128 are pivotally joined to ends of shaped beams or actuator brackets 132. Opposing ends of the actuator brackets 132 are attached to the first support frame 108 and the second support frame 116, respectively.

The articulating frame 100 further includes a mattress backing 200. The mattress backing has an upper surface 202 on which a mattress (not shown) is supported and an opposite lower surface 204. The mattress backing 200 comprises a plurality of separate panels 208a-d which are supported above the articulating frame 100 by the first support frame 108, the linking frame 104, the second support frame 116, and the third support frame 120, respectively and moving in a direction from a head end of the motorized bed 10 to a foot end of the motorized bed 10. The panels 208a-d are attached to their respective frame members. The panels 208a-d are produced from a substantially rigid material, primarily a wood. One or more of the panels 208a-d has an aperture 212 therein through which a portion of a vibration motor assembly 300 passes. The vibration motor assembly 300 comprises an electric massage or vibration motor 304, a motor mount 308, a cushion 312, and an assembly cover 316.

The massage or vibration motor 304 is of a type known on the art. It comprises a motor housing 320 and a flange 324. The motor housing 320 has a curved surface, a major portion of a sidewall of which may be a portion of a right circular cylinder truncated by, or resting on, a plane defined by an upper surface 328 of the flange 324, which upper surface 328 itself is truncated or interrupted by its intersection with the housing 320. The flange 324 is outfitted with a plurality of through holes to accommodate fasteners 332 which attach the vibration motor 304 to the motor mount 308. An example of a suitable massage motor 304 is the motor marketed under the name HJM2 by Qingdao Richriver Electrics Co., LTD.

The motor mounts 308 are used to attach vibration motors 304 to the articulating frame 100. More specifically, a plurality of vibration motors 304 are attached to the panels 208a-d, one vibration motor 304 per panel 208a-d. The motor mounts 308 comprise flexible brackets 336. Fasteners 340 attach the flexible brackets 336 to the lower surface 204 of the articulating frame 100 which corresponds to lower surfaces of the panels 208a-d. The fasteners 340 are preferably wood screws, lag screws, or the like. However, one skilled in the art would readily recognize that the preferred choice of fastener 340 would be primarily dictated by the material to which the flexible brackets 336 are attached. Thus, any type of chemical or mechanical fastener that is compatible with both panels 208a-d and the flexible brackets 336 may be employed. In the preferred embodiment, the panels 208a-d are produced from a wood.

As best illustrated in FIG. 9, the flexible brackets 336 are produced from a pliable material that is fully flexible at room temperature. The flexible brackets 336 are preferably formed from a fabric, more preferably a fabric of woven strands or strands that is strong enough to support and retain the vibration motors 304 in a desired position relative to the apertures 212 in the panels 208a-d. The strands can be natural but are preferably produced from a polymeric material with an elastic quality that allows the flexible brackets 336 to expand and return to their original dimensions under the forces experienced during intended use.

The flanges 324 of the vibration motors 304 are attached to the flexible brackets 336 using fasteners 332, and the flexible brackets 336 are attached to the lower surfaces of the panels 208a-d. This arrangement allows the housing 320 of each vibration motor 304 to be oriented upwardly and extend into a corresponding aperture 212 with the flange 324 oriented downwardly relative to the lower surface of the panel. The housing 320 preferably extends into and through the aperture 212 and upwardly such that a portion of the motor housing 320 extends above a plane defined by the upper surface 202 of the mattress backing 200. Thus, the vibration motors 304 are suspended from the lower surface 204 of the mattress backing 200 wherein the flexible brackets 336 are deflectable such that the vibration motors 304 are movable within the aperture 212.

The motor assemblies 300 further comprise cushions 312 which preferably substantially surround the housings 320 within the apertures 212 such that a portion of each cushion 312 is located between the housings 320 and the mattress backing to prevent contact of the housings 320 with sidewalls 220 of the mattress backing 200 that define an aperture 212 shape the within the aperture and between vibration motor and the mattress backing 200. The cushions 312 are preferably produced from a foam material.

Covers 316 are provided to conceal and protect vibration motors 304. The covers 316 are generally produced from a fabric and attached to the lower surface of the articulating frame 100 via hook and loop fasteners. The covers 316 preferably fully conceal the vibration motors 304 and the apertures 212.

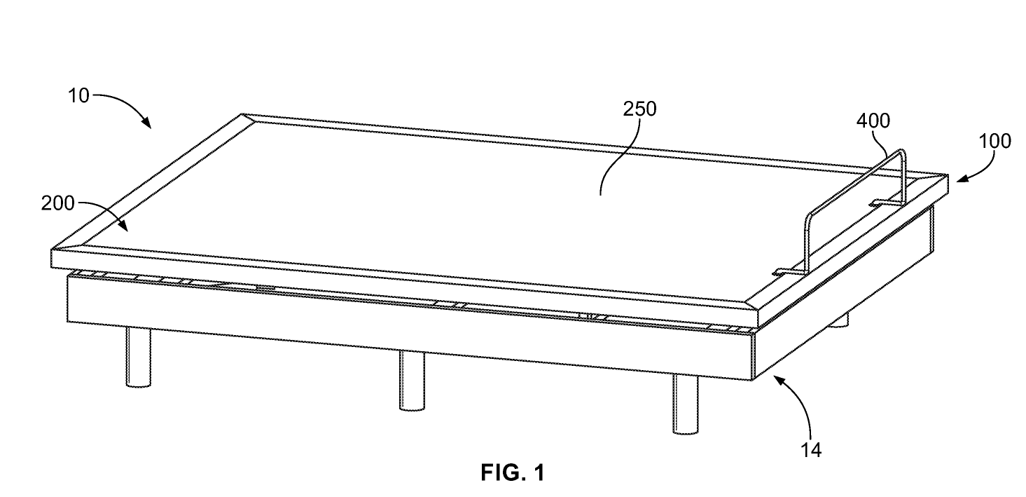

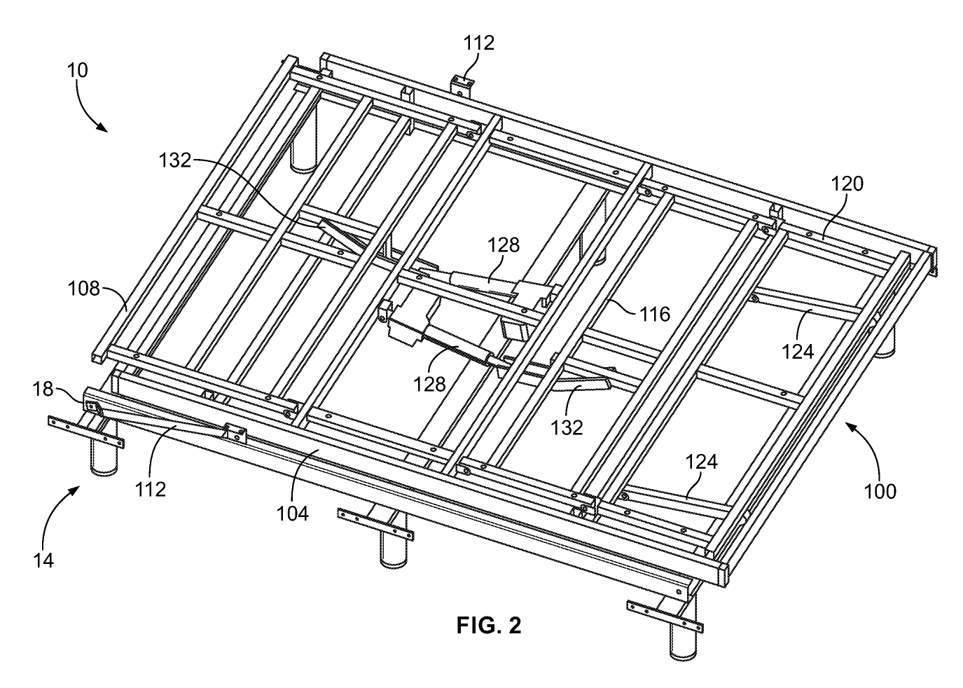

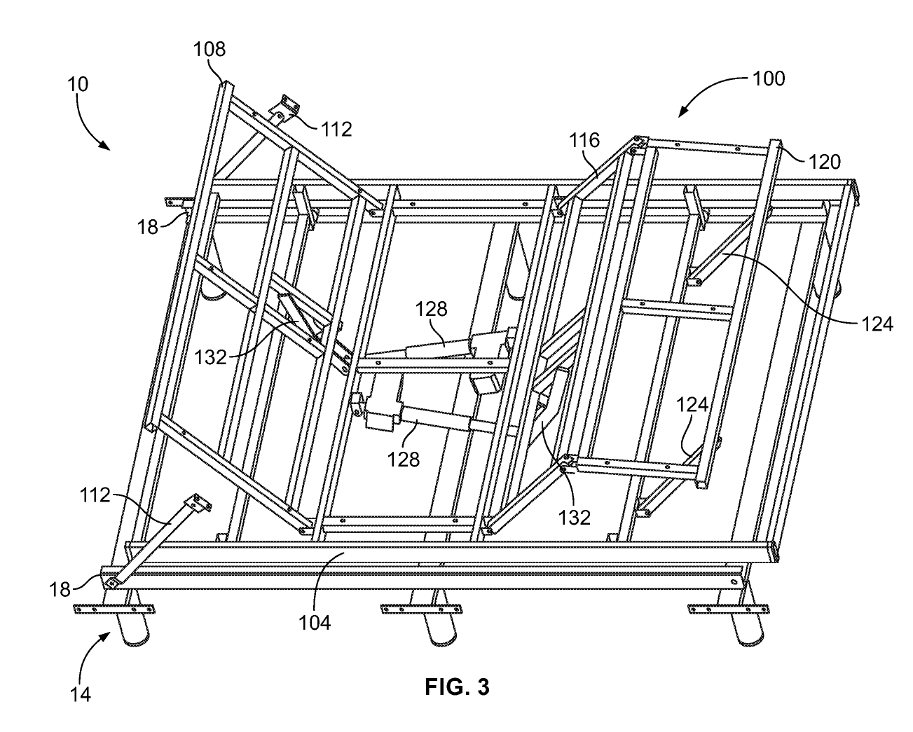

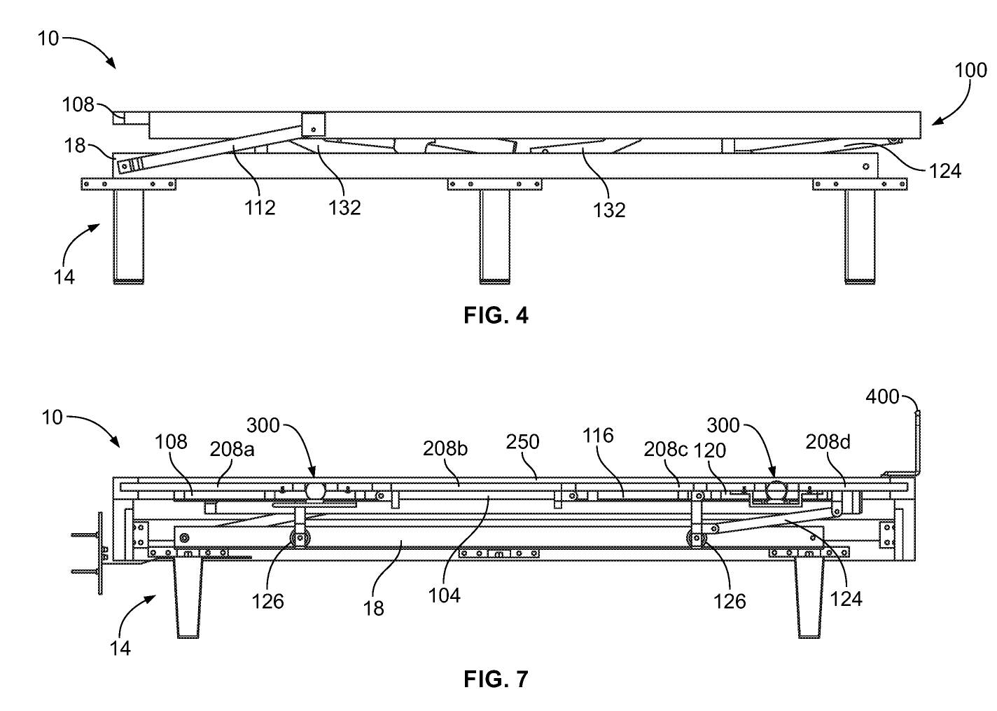

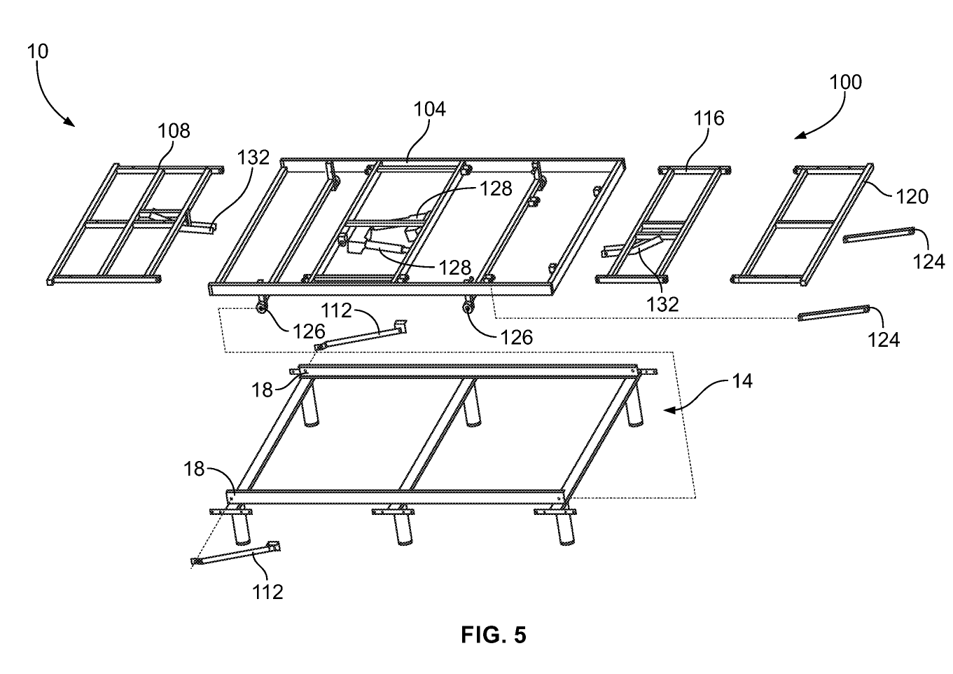

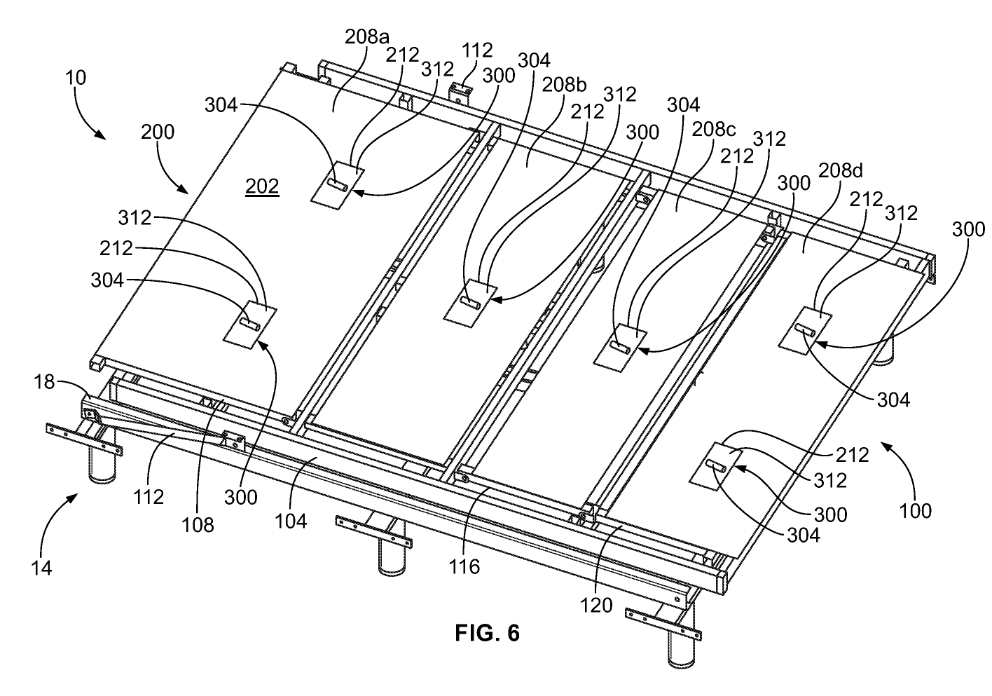

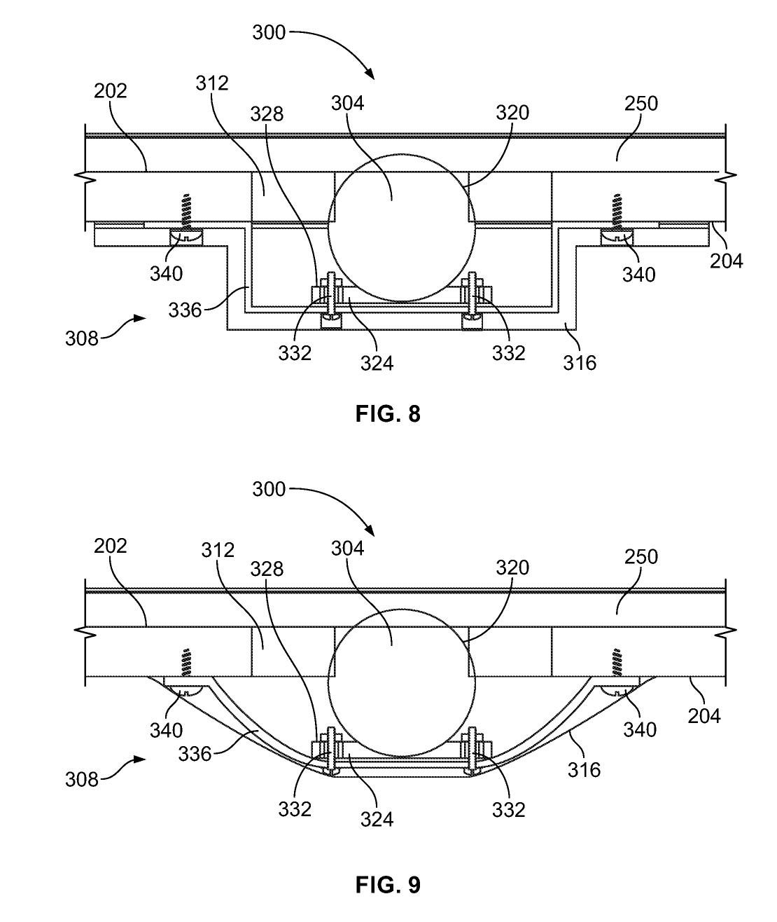

As illustrated best in FIGS. 1, 8 and 9, the upper surface 202 of the mattress backing 200 can have a padding 250 supported thereon. The padding 250 covers the apertures 212 and the motor assemblies 300, providing a barrier between a mattress (not shown) and the panels 208a-d.

The motorized bed 10 may further comprise a mattress retainer 400 as illustrated in FIG. 1. The mattress retainer 400 prevents a mattress (not shown) from unwanted movement from the foot of the bed frame 10.

While the specific embodiments have been illustrated and described, numerous modifications come to mind without significantly departing from the spirit of the invention, and the scope of protection is only limited by the scope of the accompanying Claims.

What is claimed is:

1. A motorized bed, comprising:
a base frame;
an articulating frame attached to the base frame having an upper surface on which a mattress is supported and an opposite lower surface, the articulating frame comprising:
a linking frame attached to the base frame
a plurality of support frames pivotally mounted on the linking frame;
a plurality of support members joining the support frames with the linking frame; and
a mattress backing supported by the support frames;
a vibration motor mounted to the articulating frame; and
a vibration motor mount comprising:
a flexible bracket fixed to the lower surface of the articulating frame and the vibration motor to suspend the vibration motor from the lower surface of the articulating frame.

2. The motorized bed of claim 1 further comprising:
an aperture in the mattress backing wherein the vibration motor is mounted within the aperture.

3. The motorized bed of claim 2 further comprising:
a cushion within the aperture and between vibration motor and the mattress backing.

4. The motorized bed of claim 3 further comprising:
a cover attached to the lower surface of the articulating frame and covering the vibration motor and the flexible bracket.

5. The motorized bed of claim 4 wherein the cover is attached to the mattress backing by a hook and loop fastener.

6. The motorized bed of claim 5 wherein the flexible bracket is produced from a fabric.

7. The motorized bed of claim 6 wherein the fabric comprises woven strands.

8. The motorized bed of claim 7 wherein the message motor comprises a flange joined to a curved motor housing and wherein the flange is oriented downwardly relative to the lower surface and the curved housing extends into the aperture.

9. The motorized bed of claim 8 wherein the curved motor housing extends through the aperture and upwardly such that a portion of the curved motor housing extends above a plane defined by the upper surface of the mattress backing.

10. The motorized bed of claim 9 wherein the flange is attached to the flexible bracket by mechanical fasteners.

11. The motorized bed of claim 10 wherein the flexible bracket deflects under forces provided by the vibration motor.

12. The motorized bed of claim 10 wherein the flexible bracket is deflectable such that the vibration motor is movable within the aperture.

13. The motorized bed of claim 9 wherein the mattress backing is produced from a rigid material.

14. The motorized bed of claim 13 wherein the mattress backing is produced from a wood.

15. The motorized bed of claim 13 wherein the flexible bracket is fastened to the mattress backing with a mechanical fastener.

16. A motorized bed, comprising:
a base frame;
an articulating frame attached to the base frame having an upper surface on which a mattress is supported and an opposite lower surface, the articulating frame comprising:
a linking frame attached to the base frame
a plurality of support frames pivotally mounted on the linking frame;
a plurality of support members joining the support frames with the linking frame; and
a mattress backing supported by the support frames comprising an upper surface on which a mattress is supported, an opposite lower surface, and an aperture passing therethrough;
a vibration motor mounted to the articulating frame and extending within the aperture in the mattress backing, the vibration motor comprising:
a flange; and
a curved motor housing joined to the flange wherein the flange is oriented downwardly relative to the lower surface of the mattress backing and the curved housing extends into the aperture in the mattress backing;
a vibration motor mount attaching the vibration motor to the mattress backing and orienting the vibration motor within the aperture.

17. The motorized bed of claim 16 wherein the motor mount is deflectable such that the vibration motor is movable within the aperture.

18. The motorized bed of claim 16 further comprising:
a cushion within the aperture and between vibration motor and the mattress backing.

19. The motorized bed of claim 16 wherein the vibration motor mount comprises a flexible bracket fixed to the lower surface of the articulating frame and the vibration motor to suspend the vibration motor from lower surface of the articulating frame

20. A motorized bed, comprising:
a base frame;
an articulating frame attached to the base frame, the articulating frame comprising:
a linking frame attached to the base frame
a plurality of support frames pivotally mounted on the linking frame;
a plurality of support members joining the support frames with the linking frame; and
a mattress backing produced from a rigid material and supported by the support frames, the mattress backing comprising an upper surface on which a mattress is supported, an opposite lower surface, and an aperture passing therethrough;
a vibration motor mounted within the aperture, the vibration motor comprising:
a flange; and
a curved motor housing joined to the flange wherein the flange is oriented downwardly relative to the lower surface of the mattress backing and the curved housing extends into the aperture into and through the aperture and upwardly such that a portion of the curved motor housing extends above a plane defined by the upper surface of the mattress backing;
a vibration motor mount comprising a flexible bracket produced from a fabric of woven strands fixed to the lower surface of the mattress backing and the vibration motor to suspend the vibration motor from lower surface of the mattress backing wherein the flexible bracket is deflectable such that the vibration motor is movable within the aperture;
a cushion within the aperture and between vibration motor and the mattress backing; and
a cover attached to the lower surface of the mattress backing and covering the vibration motor and the flexible bracket wherein the cover is attached to the mattress backing by a hook and loop fastener.
